(19) United States
(12) Patent Application Publication
(10) Pub. No.: US 2011/0005673 A1
(43) Pub. Date: Jan. 13, 2011

(54) MOUNTING MAT

(76) Inventor: Ian F. Lebauer, Maple Lake, MN (US)

Correspondence Address: LEFFERT JAY & POLGLAZE, P.A., P.O. BOX 581009, MINNEAPOLIS, MN, 55458-1009, US

(21) Appl. No.: 12/500,250

(22) Filed: Jul. 9, 2009

(51) Int. Cl. B32B 38/00; B32B 3/06; B32B 37/00

(52) U.S. Cl. 156/285; 428/99; 156/60

(57) ABSTRACT

An embodiment of a mounting mat has a first portion that is non-tacky and substantially non-porous. The first portion is configured to suctionally attach to a mounting device that is attachable to a device to be mounted. A second portion of the mat is permanently attached to the first portion. The second portion is pliable and tacky and is configured to removably grip a surface for removably affixing the mounting mat to the surface.

### FIELD

The present disclosure relates generally to mounting apparatus, and, in particular, the present disclosure relates to a mounting mat.

### BACKGROUND

With the advent of portable electronic devices, such as satellite radios, mp3 players, mobile telephones, personal digital assistants, global positioning satellite devices, etc., the use of these devices in motor vehicles is becoming commonplace. Electronic devices typically have a display screen for displaying information to a user, and when the device is mounted in a motor vehicle, the user usually adjusts the angle of the device to enhance viewing the display screen and to eliminate glare, for example.

Electronic devices may be permanently or temporarily mounted within a motor vehicle. For example, mounting apparatus are typically used to secure, either temporarily or permanently, an electronic device to a surface within a motor vehicle to prevent the electronic device from moving in response to the motion of the motor vehicle and to allow the electronic device to be viewed, heard, or physically operated. For example, electronic devices can be secured to the dashboard, windshield, or floor, or other surfaces, of a motor vehicle using suction cups, adhesive tape, screws, metal or plastic clips, etc.

Permanent mounting of devices has several drawbacks, such as preventing the user from moving the device to an alternate vehicle and preventing the user from retaining the electronic device if and when the user dispossesses the vehicle. Additionally, the permanent mounting of electronic devices in a vehicle, if attempted to be undone, almost inevitably results in damage to the surface of the vehicle where mounting hardware was affixed. For example, screw-holes or non-removable adhesive residue may be left in or on the mounting surface. This can lower resale value and is usually forbidden on leased vehicles.

Temporary mounting apparatus for electronic devices eliminate some of the drawbacks associated with permanent mounting but, nevertheless, have drawbacks. For example, some temporary mounting apparatus for electronic devices rely on their size and/or weight to temporarily mount the electronic device on a surface within a motor vehicle and are sometimes 2 to 3 times larger than the average size of the electronic device and are sometimes 4 to 5 times heavier than the electronic device.

Other temporary mounting apparatus involve using a compliant mat having a tacky bottom surface that allows the mat to cling to a surface within the motor vehicle and having a tacky upper surface that clings to the electronic device. However, the tacky upper surface can collect debris. In addition, the rear surface, opposite the display screen, of the electronic device clings to the tacky upper surface of the mat so that the device is substantially parallel to the mat and thus the surface within the motor vehicle. This makes the device difficult to view in that the device is not in its normal upright viewing position.

For the reasons stated above, and for other reasons which will become apparent to those skilled in the art upon reading and understanding the present specification, there is a need in the art for alternative apparatus for mounting devices within motor vehicles.

### BRIEF DESCRIPTION OF THE DRAWINGS

FIG. 1 is a cutaway isometric view of a mounting mat, according to an embodiment.

FIG. 2 is a cutaway isometric view of a mounting mat, according to another embodiment.

FIGS. 3 and 4 are top isometric views illustrating mounting mats of different shapes, according to another embodiment.

FIG. 5 is a cutaway isometric view of a mount for a device, according to another embodiment.

FIG. 6 is a cutaway isometric view of a mounting mat, according to another embodiment.

### SUMMARY

One embodiment of the disclosure provides a mounting mat. The mounting mat has a first portion that is non-tacky and substantially non-porous. The first portion is configured to suctionally attach to a mounting device that is attachable to a device. A second portion of the mounting mat is permanently attached to the first portion. The second portion is pliable and tacky and is configured to removably grip a surface for removably attaching the mounting mat to the surface.

### DETAILED DESCRIPTION

In the following detailed description, reference is made to the accompanying drawings that form a part hereof, and in which is shown, by way of illustration, specific embodiments. In the drawings, like numerals describe substantially similar components throughout the several views. Other embodiments may be utilized and structural changes may be made without departing from the scope of the present disclosure. The following detailed description is, therefore, not to be taken in a limiting sense, and the scope of the present disclosure is defined only by the appended claims and equivalents thereof.

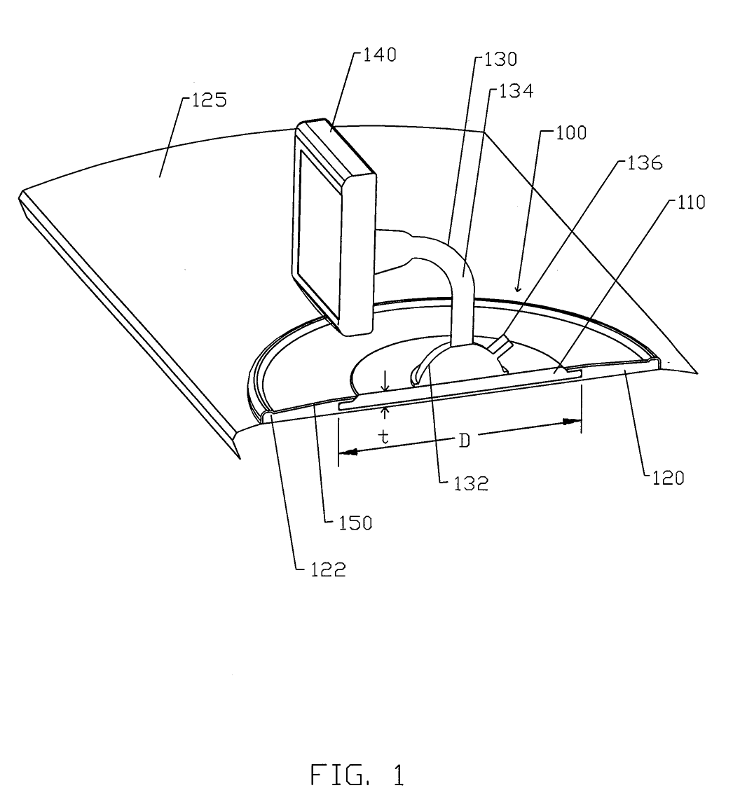

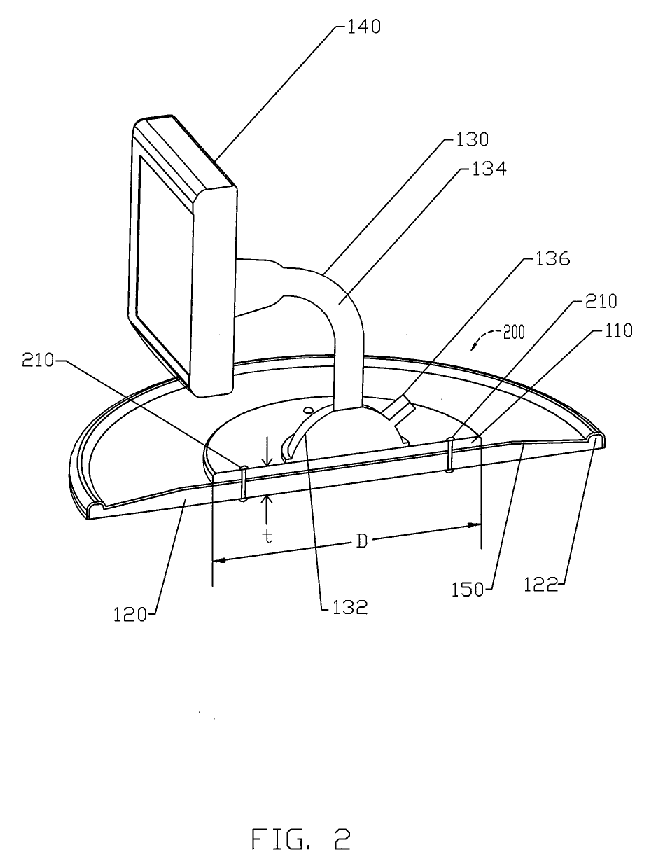

FIGS. 1 and 2 are cutaway isometric views of mounting mats (e.g., holding mats, such as mounting mat 100 (FIG. 1) and mounting mat 200 (FIG. 2). Mounting mats 100 and 200 each have a portion 110, such as a plate, that is non-removably (e.g., permanently) attached to a portion 120 (e.g., a non-skid portion) of the mat. Portion 110 is of a non-tacky, rigid (e.g., substantially rigid), and non-porous (e.g., substantially non-porous) material, such as metal, e.g., aluminum, plastic, e.g., plexiglass, acrylonitrile butadiene styrene (ABS), etc.

Portion 120 is of a pliant (e.g., flexible) tacky (e.g., non-skid) material that can removably (e.g., temporarily) mechanically (e.g., frictionally) grip (e.g., cling to, adhere to) a surface 125, such as a dashboard or any other surface within a motor vehicle, without marring or chemically reacting with the surface 125, as shown in FIG. 1. That is, portion 120 forms a temporary, non-chemical bond with surface 125 so that mats 100 and 200 can temporarily adhere directly to surface 125 and be removed without damaging surface 125. Portion 120 may be permanently tacky or be renewably tacky, where tackiness can be renewed by washing portion 120. Therefore, mats 100 and 200 are reusable in that they can be removed from and subsequently reapplied to various surfaces. Non-limiting examples of suitable materials for portion 120 include expanded vinyl and molded polyurethane.

Portion 110 is configured to suctionally attach to a mounting device 130 that may be removably (e.g., temporarily) attachable to a device, such as an electronic device 140, e.g., a portable electronic device. Non-limiting examples of electronic devices include global positioning systems, radios, cellular telephones, two-way radios, personal digital assistants, mp3 players, etc.

Mounting device 130 may include a vacuum suction device 132, such as a suction cup, that is attached to an arm 134 that may be removably (e.g., temporarily) attachable to electronic device 140. Suction device 132 may include an actuator 136, such as a lever or knob, that selectively causes suction device 132 to exert at least a partial vacuum on portion 110. As such, portion 110 is configured to maintain at least a partial vacuum induced by the suctional attachment between suction device 132 and portion 110. The suctional attachment between suction device 132 and portion 110 removably (e.g., temporarily) attaches mounting device 130 to portion 110.

As shown in FIG. 1, mounting device 130, with electronic device 140 removably attached thereto, is suctionally attached to portion 110 while portion 120 conforms to surface 125 and the bottom surface of portion 120 removably grips surface 125. Rigid, non-porous portion 110 enables the removable, suctional attachment of mounting device 130 thereto.

Mounting device 130 maintains electronic device 140 in a normal upright position for easier viewing and user access. This overcomes problems associated with conventional holding mats, where the rear portion of an electronic device is removably adhered directly to a tacky upper surface of a mat, making the electronic device difficult to view and access in that the device is not in its normal upright position. In addition, suctionally attaching mounting device 130 to portion 110 overcomes problems associated with attempting to suctionally attach mounting device 130 directly to the upper surface of a conventional mounting mat that is removably adhered to a surface in that the suction acts to pull the mat from the surface, thereby preventing the mat from securing mounting device 130 to the surface.

A portion of portion 120 may be overmolded over a portion of portion 110 to permanently attach portion 120 to portion 110, as shown in FIG. 1. Alternatively, portions 110 and 120 may be permanently attached to each other using rivets 210, as shown in FIG. 2, using an adhesive, etc. For example, portion 110 may be bonded, e.g., using the adhesive, directly to the upper surface of portion 120.

For one embodiment, a pliant (e.g., flexible), non-tacky covering 150 is permanently attached to an upper surface of portion 120, e.g. by an adhesive, to permanently cover the upper surface of portion 120 adjacent portion 110. For example, covering 150 of mat 100 may surround and contact portion 110 of mat 100, as shown in FIG. 1, e.g., when the portion of portion 120 of mat 100 is over molded over the portion of portion 110 of mat 100 or when portion 110 of mat 100 is bonded directly to the upper surface of portion 120 of mat 100.

Alternatively, a portion of covering 150 may surround portion 110 of mat 200 and another portion of covering 150 may be interposed between portions 110 and 120 of mat 200, as shown in FIG. 2. For another embodiment, portion 110 of mat 200 may be bonded directly to the upper surface of covering 150, with covering 150 being interposed between portions 110 and 120 of mat 200.

Covering 150 and portion 110 respectively form non-tacky, pliant and non-tacky, rigid portions of an upper surface of mats 100 and 200. Non-limiting examples of covering 150 include LYCRA, nylon rubber, ethylene-butyl-acrylate (EBA), or other suitable non-tacky, flexible fabrics. Covering 150 acts to prevent debris from otherwise adhering to the upper surface of portion 120 if left exposed.

An optional ridge 122 may protrude from the upper surface of portion 120 and extend around a perimeter of portion 120, and thus of each of mats 100 and 200, as shown in FIGS. 1 and 2. Ridge 122 may be permanently covered by covering 150. The optional ridge increases the weight of mats 100 and 200, thereby increasing frictional adhesion between mats 100 and 200 and surface 125. Alternatively, ridge 122 may be omitted.

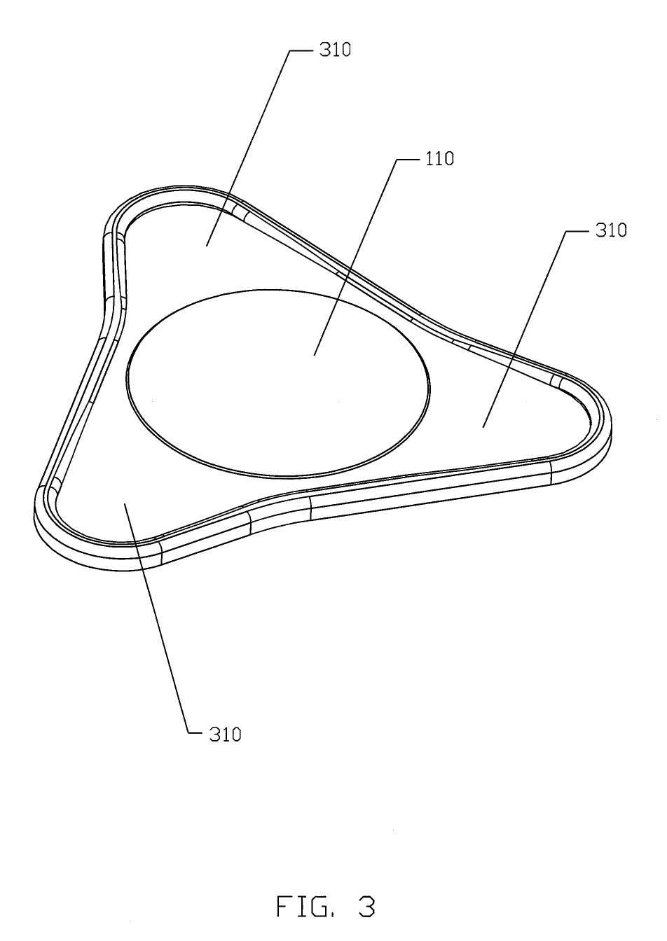

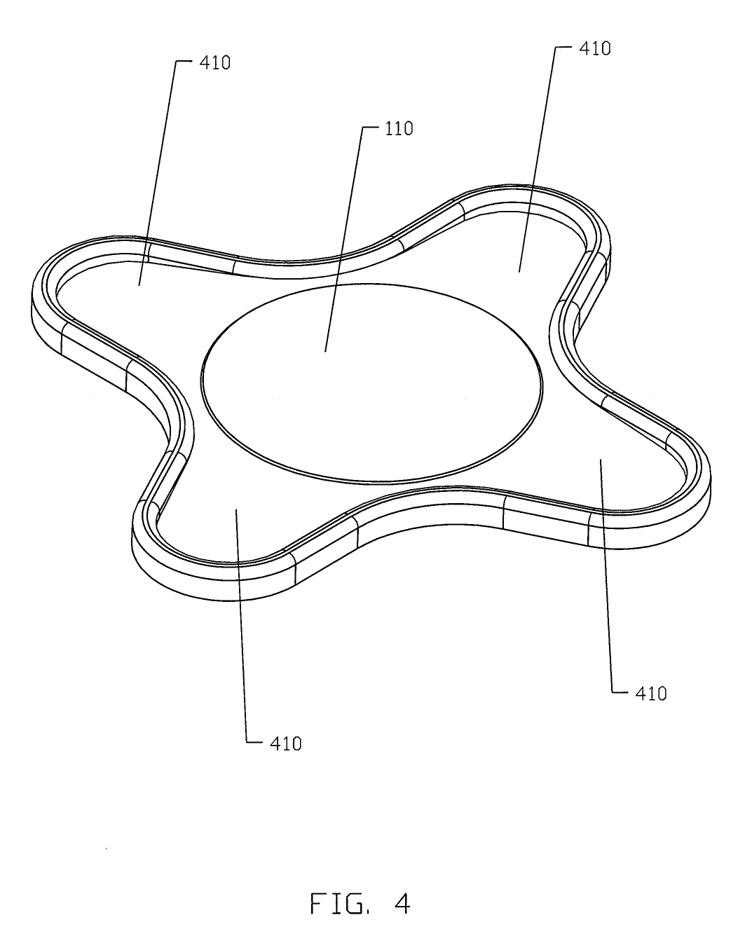

Mats 100 and 200 may be circular in shape when viewed from the top. Alternatively, mats 100 and 200 may be square or rectangular in shape when viewed from the top. For other embodiments, mats 100 and 200 may include a plurality of independently flexible lobes 310 or 410 (e.g., appendages) extending radially outward from a perimeter of portion 110, as respectively shown in FIGS. 3 and 4. Each of lobes 310 and 410 is configured to independently removably (e.g., temporarily) grip the surface 125. Note that lobes 310 and 410 act to increase the flexibility of portion 120 and thus of mats 100 and 200.

Note that the flexibility of mats 100 and 200 is reduced as the diameter (e.g., the surface area) of rigid portion 110 increases, making it difficult for mats 100 and 200 to conform to the contour of surface 125 and thus to adhere to surface 125. Therefore, for one embodiment, an exposed portion of portion 110 may have a diameter D of about the same size as the diameter of suction device 132. For example, the diameter of the exposed portion of portion 110 may be at most about five inches, or the area of the upper surface of portion 110 may be at most about 10 in².

The ability of mats 100 and 200 to cling to surface 125, and thus to maintain mounting device 130, with electronic device 140 attached thereto, on surface 125, depends on the area of the bottom surface of portion 120 that is in contact with surface 125. Therefore, for some embodiments, the area of the bottom surface of portion 120 may be at least 30 in². A thickness t of mat 200 and of the thickest portion of mat 100 (FIG. 1) may be at most about 0.5 in. for one embodiment. The weight of each of mats 100 and 200 may be at most about four oz.

For other embodiments, portion 110 of either mat 100 or mat 200 may be pliant, but yet sufficiently rigid to maintain mounting device 130 in the upright position shown in FIGS. 1 and 2. For example, when pliant, portion 110 is still sufficiently rigid so that the suction of suction device 132 cannot pull portion 120 from contact with surface 125. Portion 110, when pliant, may also be sufficiently non-porous to maintain at least a partial vacuum induced by the suctional attachment between mounting device 130 and portion 110. Portion 110, when pliant, is less porous and/or less pliant than portion 120 for another embodiment. A suitable material for portion 110, when pliant, is a thermal plastic elastomer.

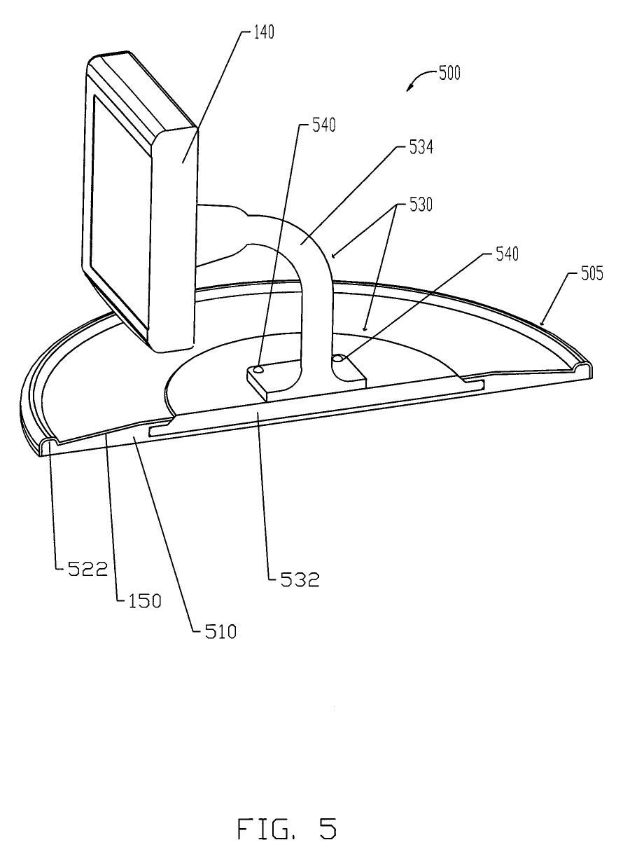

FIG. 5 is a cutaway isometric view of a mount 500 for a device, such as electronic device 140, according to another embodiment. Mount 500 includes a flexible mat 505 having a renewably or permanently tacky bottom surface that is configured to removably mechanically grip a surface, such as surface 125 of FIG. 1, for removably attaching mat 505, and thus mount 500, to surface 125. A mounting device 530 that is removably connectable to electronic 140 is permanently attached to mat 505.

Mat 505 includes a layer 510 having a bottom surface that forms the bottom surface of mat 505. Layer 510 may be of the same material as portion 120 of mats 100 and 200, e.g., of expanded vinyl, molded polyurethane, etc., as discussed above in conjunction with FIGS. 1 and 2.

Mounting device 530 may include a rigid (e.g., substantially rigid) plate 532 that can be of the same material as portion 110 of mats 100 and 200, as described above in conjunction with FIGS. 1 and 2. Mounting device 130 may include an arm 534 permanently attached to plate 520, e.g., by rivets 540, an adhesive, etc. Alternatively, plate 532 and arm 534 may be integral parts of mounting device 530, e.g., integrally formed by molding.

A portion of layer 510 of mat 505 may be over molded over a portion of plate 532 of mounting device 530 to permanently attach mounting device 530 to mat 505, as shown in FIG. 5. Alternatively, plate 532, and thus mounting device 530, may be permanently attached to mat 505 using an adhesive, using rivets, e.g., in a manner similar to that shown in FIG. 2 and described above in conjunction with FIG. 2, etc. For example, plate 532 may be bonded, e.g., using the adhesive, directly to the upper surface of layer 510.

For one embodiment, the pliant (e.g., flexible), non-tacky covering 150 may be permanently attached to an upper surface of layer 510, e.g. by an adhesive, to permanently cover the upper surface of layer 510 adjacent plate 532. For example, covering 150 may surround and contact plate 532, as shown in FIG. 5, e.g., when the portion of layer 510 of mat 505 is over molded over the portion of plate 532 or when plate 532 is bonded directly to the upper surface of layer 510. As such, covering 150 forms a non-tacky upper surface of mat 505.

Alternatively, a portion of covering 150 may surround plate 532 and another portion of covering 150 may be interposed between plate 532 and layer 510, e.g., when mounting device 530 is riveted to layer 510. For another embodiment, plate 532 may be bonded directly to the upper surface of covering 150, with covering 150 being interposed between plate 532 and layer 510.

An optional ridge 522 may protrude from the upper surface of layer 510 and may extend around a perimeter of layer 510, and thus of mat 505, as shown in FIG. 5. Ridge 122 may be permanently covered by covering 150. Alternatively, ridge 522 may be omitted.

Mat 505 may be circular in shape when viewed from the top, as shown in FIG. 5, or be square or rectangular in shape when viewed from the top. For other embodiments, mat 505 may include a plurality of independently flexible lobes (e.g., similar to the lobes 310 or 410 shown in FIGS. 3 and 4) extending radially outward from a perimeter of plate 532. Each of the lobes is configured to independently removably (e.g., temporarily) grip the surface on which mount 500 is mounted.

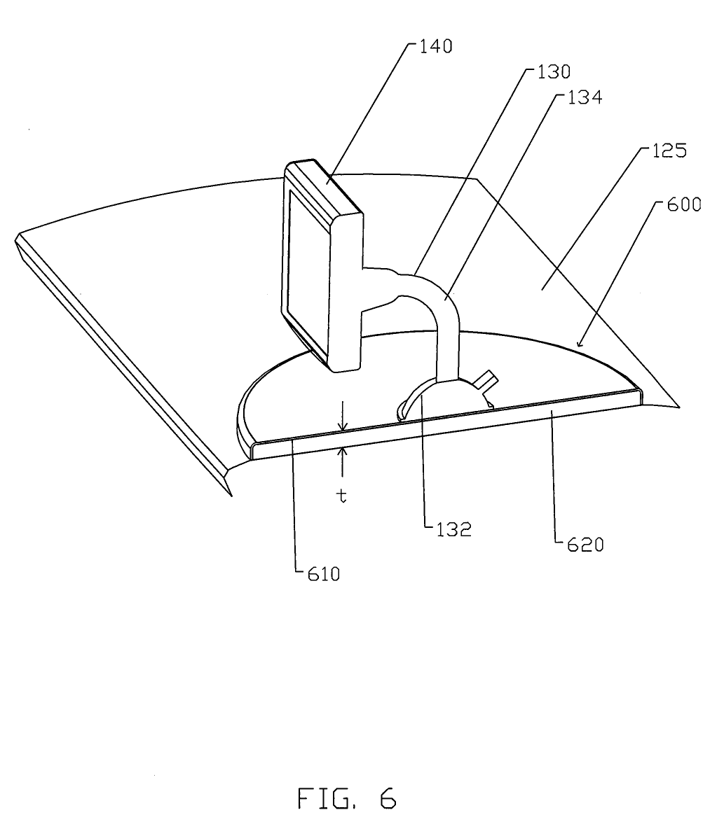

FIG. 6 is a cutaway isometric view of a mounting mat 600. Mat 600 has a flexible layer 620 that is permanently or renewably tacky and that is configured to removably mechanically grip surface 125 while conforming to a contour of surface 125. A flexible, non-tacky, non-porous (e.g., substantially non-porous) layer 610 is formed over layer 620. For example, layer 610 may be permanently attached to layer 620, e.g., by gluing. Layer 610 is configured to suctionally attach to the mounting device 130 for electronic device 140, e.g., in a manner similar to that described above for portion 110 of mats 100 and 200 in conjunction with FIGS. 1 and 2. Note that the suctional attachment removably (e.g., temporarily) attaches mounting device 130 to layer 610.

Layer 620 may be of the same material as portion 120, e.g., of expanded vinyl, molded polyurethane, etc., as discussed above in conjunction with FIGS. 1 and 2. Layer 610 may be a thermal plastic elastomer.

Layer 610 is sufficiently non-porous to maintain at least a partial vacuum induced by the suctional attachment between suction device 132 of mounting device 130 and layer 610. Layer 610 is further sufficiently rigid to maintain mounting device 130 in the upright position shown in FIG. 6. For example, layer 110 is sufficiently rigid so that the suction of suction device 132 cannot pull layer 120 from contact with surface 125. For one embodiment, layer 610 may be less porous and/or less flexible than layer 620.

Mat 600 may be circular in shape when viewed from the top, as shown in FIG. 6, or be square or rectangular in shape when viewed from the top. For other embodiments, mat 600 may include a plurality of independently flexible lobes (e.g., similar to the lobes 310 or 410 shown in FIGS. 3 and 4) extending radially outward from the center of mat 600. Each of the lobes is configured to independently removably (e.g., temporarily) grip surface 125. The thickness t of mat 600 may be at most about 0.5 in. For some embodiments, the area of the bottom surface of layer 620 may be at least 30 in². The weight of mat 600 may be at most about four oz. for other embodiments.

### Conclusion

Although specific embodiments have been illustrated and described herein, it will be appreciated by those of ordinary skill in the art that any arrangement that is calculated to achieve the same purpose may be substituted for the specific embodiments shown. Many adaptations of the embodiments will be apparent to those of ordinary skill in the art. Accordingly, this application is intended to cover any adaptations or variations of the embodiments. It is manifestly intended that the embodiments be limited only by the following claims and equivalents thereof.

What is claimed is:

1. A mounting mat, comprising:
a first portion that is non-tacky and substantially non-porous, the first portion configured to suctionally attach to a mounting device that is attachable to a device to be mounted; and
a second portion permanently attached to the first portion that is pliable and tacky and that is configured to removably grip a surface for removably attaching the mounting mat to the surface.

2. The mounting mat of claim 1, wherein a portion of the second portion is molded over a portion of the first portion or wherein the first portion is riveted or bonded to the second portion.

3. The mounting mat of claim 1, further comprising a pliant, non-tacky covering permanently covering an upper surface of the second portion adjacent the first portion.

4. The mounting mat of claim 1, wherein the second portion is permanently or renewably tacky.

5. The mounting mat of claim 1, wherein the first portion is configured to maintain at least a partial vacuum induced by the suctional attachment between the mounting device and the first portion.

6. The mounting mat of claim 1, further comprising a ridge protruding from an upper surface of the second portion of the mounting mat and disposed around a perimeter of the mounting mat.

7. The mount of claim 1, wherein the second portion of the mounting mat further comprises a plurality of independently flexible lobes, each lobe configured to independently removably grip the surface.

8. The mount of claim 1, wherein the first portion is rigid.

9. The mount of claim 1, wherein the first portion is pliable and yet sufficiently rigid to prevent suction induced by the suctional attachment between the mounting device and the first portion from pulling the second portion out of contact with the surface when the second portion removably grips the surface.

10. A mount, comprising:
a flexible mat comprising a tacky bottom surface that is configured to frictionally cling to a surface for temporarily affixing the mat to the surface; and
a mounting device connectable to the device and permanently attached to the mat.

11. The mount of claim 10, wherein the mat further comprises a non-tacky upper surface.

12. The mount of claim 10, wherein the mounting device is riveted or bonded to the mat or wherein a portion of the mat is molded over a portion of the mounting device.

13. The mount of claim 10, wherein the mounting device comprises a mounting arm permanently attached to a substantially rigid plate that is permanently attached to the mat.

14. A mounting mat, comprising:
a flexible first layer that is tacky and that is configured to removably grip a surface; and
a flexible, non-tacky, substantially non-porous second layer formed over the first layer, the second layer configured to suctionally attach to a mounting device for an electronic device.

15. The mounting mat of claim 14, wherein the second layer is a thermal plastic elastomer.

16. The mounting mat of claim 14, wherein the second layer is configured to maintain at least a partial vacuum induced by the suctional attachment between the mounting device and the second layer.

17. A method for mounting a device on a surface, comprising:
temporarily attaching a mat to the surface by gripping the surface with a tacky, flexible first portion of the mat;
attaching a mount to a non-tacky, non-porous second portion of the mat that is permanently attached to the first portion; and
attaching the device to the mount.

18. The method of claim 17, wherein attaching the mount to the second portion of the mat comprises permanently attaching the mount to the second portion of the mat.

19. The method of claim 17, wherein attaching the mount to the second portion of the mat comprises suctionally attaching the mount to the second portion of the mat.

20. The method of claim 17, wherein the second portion of the mat is a flexible material formed over the first portion of the mat.

21. The method of claim 17, wherein the second portion of the mat is substantially rigid.

22. The method of claim 17, wherein the mat further comprises a flexible, non-tacky material surrounding the second portion of the mat and permanently attached to the first portion of the mat.

23. The method of claim 17, wherein removably attaching the mat to the surface by gripping the surface with the tacky, flexible first portion of the mat further comprises independently gripping portions of the surface with a plurality of independent lobes of the mat.
